(19) United States
(12) Patent Application Publication
(10) Pub. No.: US 2009/0052860 A1
(43) Pub. Date: Feb. 26, 2009

(54) Method, Apparatus and System for Creating an Edit Manipulation List for Previously Recorded Media Content

(75) Inventors: Mike Arthur Derrenberger, Valencia, CA (US); Nour-Eddine Tazine, Noyal Sur Vilaine (FR); Robert Joseph Logan, Poway, CA (US)

Correspondence Address: Joseph J. Laks;Thomson Licensing LLC, 2 Independence Way, Patent Operations, PO Box 5312, PRINCETON, NJ, 08543, US

(73) Assignee: Thomson Licensing

(21) Appl. No.: 11/918,186

(22) PCT Filed: May 24, 2005
(86) PCT No.: PCT/US2005/018200

§ 371 Date: Oct. 9, 2007

Related U.S. Application Data
(60) Provisional application No. 60/674,076, filed on Apr. 22, 2005.

(51) Int. Cl. H04N 5/91

(52) U.S. Cl. 386/46; 386/E09.001

(57) ABSTRACT

A method, apparatus and system are provided for creating an Edit Manipulation List for selectively manipulating (e.g., playing back) portions of previously recorded media content. In one embodiment of the present invention, the creation of an Edit Playback List for selectively playing back portions of previously recorded media content includes delimiting key events in said previously recorded media content by identifying media segments within the previously recorded media content that are capable and desirable of being selectively played back and enabling a selective playback of the identified media segments. In an embodiment of the present invention, a user interface is provided for enabling a user to select which ones of the identified media segments are to be played back, thus creating an Edit Playback List.

### TECHNICAL FIELD

This invention relates to media systems, and more particularly, to creating an edit list script and edit manipulation list for selectively manipulating portions of previously recorded media content.

### BACKGROUND ART

With the advent of digital media systems, such as video recording devices and video playback devices, consumers now have the ability to control manually the video that is being played back. However, in such current digital media systems playback control is very rudimentary. For example, pans of video presentations may be skipped, slowed, fast forwarded, rewound, etc., through user interactive controls, such as a remote control. Such control is limited to real lime alterations. A user has no ability for complex changes to playback or random labeled access to portions of the media content.

### BRIEF SUMMARY OF THE INVENTION

The present invention addresses the deficiencies of the prior art by providing a method, apparatus and system for creating an edit manipulation list (EML) for selectively manipulating portions of previously recorded media content.

In one embodiment of the present invention, a method for creating an Edit Manipulation List for previously recorded media content includes delimiting key events in the previously recorded media content by identifying media segments within the previously recorded media content that are capable of being selectively manipulated (e.g., played back, re-recorded, arranged for display, edited, etc.), and enabling a selective manipulation of the identified media segments. In one embodiment of the method of the present invention, media segments in the previously recorded media content are identified by playing back the previously recorded media content and marking the locations of the media segments in the previously recorded media content. Alternatively, media segments in the previously recorded media content are identified from information regarding the previously recorded media content received from a provider of the previously recorded media content. In an alternate embodiment of the present invention, an apparatus for creating an Edit Manipulation List for previously recorded media content includes a memory for storing information and program instructions and a processor for executing the instructions, the apparatus adapted to perform the steps of identifying media segments within the previously recorded media content that are capable of being selectively manipulated and enabling a selective manipulation of the identified media segments. In various embodiments of the present invention, the apparatus is integrated in a media content receiver/playback device such as a digital video recorder (DVR), where the DVR is used to record media content from a source. In various embodiments of the present invention, the apparatus includes a user interface for enabling a user to determine which of the identified media segments are to be selectively manipulated.

In an alternate embodiment of the present invention, a system for creating an Edit Manipulation List for previously recorded media content includes a media content source for providing media content, a media content receiver for receiving and recording the media content and a control unit in communication with the media content receiver including at least a memory for storing information and program instructions and a processor for executing the instructions, where the control unit is adapted to perform the steps of identifying media segments within the previously recorded media content that are capable of being selectively manipulated and enabling a selective manipulation of the identified media segments. In one embodiment of the present invention, the media content receiver is a digital video recorder (DVR) and the control unit is integrated into the DVR.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a media content broadcast system including an Edit List Script (ELS) control unit in accordance with one embodiment of the present invention;

FIG. 2 depicts a high level block diagram of an embodiment of an ELS control unit suitable for use in the media content broadcast system of FIG. 1;

FIG. 3 depicts a high level block diagram of the concept of an Edit List Script (ELS) in accordance with one embodiment of the present invention;

FIG. 4 depicts an example, simple declarative ELS in accordance with one embodiment of the present invention; and

FIG. 5 depicts an embodiment of a user interface for user manipulation of the Edit List Script (ELS) of FIG. 4 for determining an Edit Manipulation List (EML).

To facilitate understanding, identical reference numerals have been used, where possible, to designate identical elements that are common to the figures.

### DETAILED DESCRIPTION

The present invention advantageously provides a method, apparatus and system for creating an edit list script for selectively manipulating (e.g., playing back) portions of previously recorded media content. Although throughout the teachings herein and in various embodiments of the present invention, the aspects of the present invention are described with respect to a digital video recorder/set top box and playing back portions of previously recorded audio and video content, the specific embodiments of the present invention should not be treated as limiting the scope of the invention. It will be appreciated by those skilled in the art and informed by the teachings of the present invention that the concepts of the present invention can be advantageously applied in substantially any digital device capable of manipulating (e.g., re-recording, playing back, arranging for display, editing, etc.) media content, such as a DVD player, a digital video recorder (DVR), and a Video on Demand (VOD) server. Further, the concept can be applied to non-temporal applications such as providing a spatial or content edit list, such as for editing a newspaper or a magazine.

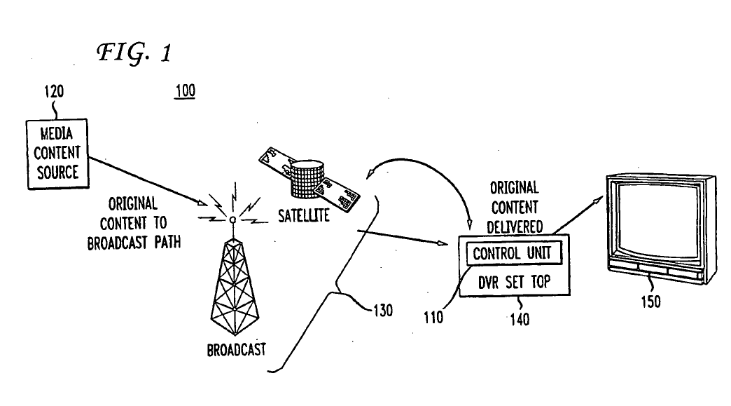

FIG. 1 depicts a high level block diagram of a media content broadcast system including an Edit List Script (ELS) control unit 110 in accordance with one embodiment of the present invention. More specifically, FIG. 1 depicts a media content broadcast system 100 including a media content source (provider) 120, a broadcast device (e.g., a broadcast lower, satellite, etc.) 130, a media content receiver (illustratively a Digital Video Recorder (DVR) Set Top Box) 140 comprising an ELS control unit 110 in accordance with an embodiment of the present invention, and an output device (illustratively a television) 150. The media content broadcast system 100 of FIG. 1 implements an Edit List Script (ELS) of the present invention to provide a user of, for example, the DVR Set Top Box 140 with the ability to selectively manipulate (e.g., play back, display, re-record, arrange, edit, etc.) at least a portion of previously recorded media content and, as such, to create an Edit Manipulation List (EML), such as an Edit Playback List. The user determined Edit Manipulation List is then executed. For example, the media segments of a determined Edit Playback List are then played back using the DVR Set Top Box 140. The selected media segments in the Edit Manipulation List can also be selected by a user for re-recording in a particularly arranged order or for editing of the selected media segments and other like manipulations. Although in the media content broadcast system 100 of FIG. 1 the media content source 120 is depicted as a remote media content source 120, in alternate embodiments of the present invention, the media content source may comprises a local media content source such as a DVD or DVD player, a compact disc (CD) or CD player, a digital video recorder (DVR), a laser disk player, or other suitable media content receiver or player and the like. In addition, the output device of the media content system 100 of FIG. 1 can comprise substantially any output device such as a display device for outputting video and audio information, a speaker system for outputting audio, and the like. Although in the media content broadcast system 100 of FIG. 1, the control unit 110 of the present invention is depicted as an integral part of the media content receiver 140, in alternate embodiments of the present invention, a control unit of the present invention may comprise a stand-alone unit.

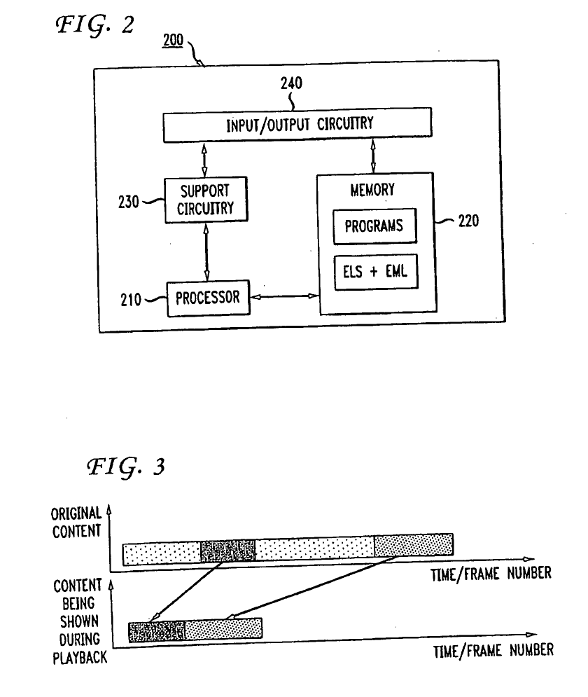

In the media content broadcast system 100 of FIG. 1, the media content from the media content source 120 is received and recorded by the DVR Set Top Box 140 comprising the ELS control unit 110. FIG. 2 depicts a high level block diagram of an embodiment of an ELS control unit 110 suitable for use in the DVR Set Top Box 140 of the media content broadcast system 100 of FIG. 1. More specifically, the ELS control unit 110 of FIG. 2 illustratively comprises a processor 210 as well as a memory 220 for storing control programs, algorithms, stored media and the like. The processor 210 cooperates with conventional support circuitry 230 such as power supplies, clock circuits, cache memory and the like as well as circuits that assist in executing the software routines stored in the memory 220. As such, it is contemplated that some of the process steps discussed herein as software processes may be implemented within hardware, for example, as circuitry thai cooperates with the processor 210 to perform various steps. The ELS control unit 110 also contains input-output circuitry 240 that forms an interface between the various functional elements communicating with the ELS control unit 110.

Although the ELS control unit 110 of FIG. 2 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

In accordance with the present invention, an Edit List Script (ELS) is defined for facilitating the selective manipulation (e.g., playing back, re-recording, displaying, etc.) of previously recorded media content. For example, FIG. 3 depicts a high level block diagram of the concept of an Edit List Script (ELS) in accordance with one embodiment of the present invention. As depicted in FIG. 3, temporally linear media content is analyzed, and cut-points of segments (e.g., audio/video segments) are created. The media content segments can then be selectively manipulated. For example, the media content segments can be selectively “spliced” together to create different playback sequences or they can be indexed to facilitate direct random access of individual playback of the segments. An ELS in accordance with at least one embodiment of the present invention is a series of declarative commands that provide instructions for where the previously described segments exist within the original content. An Edit Manipulation list in accordance with at least one embodiment of the present invention is a list of individual media content segments to be manipulated.

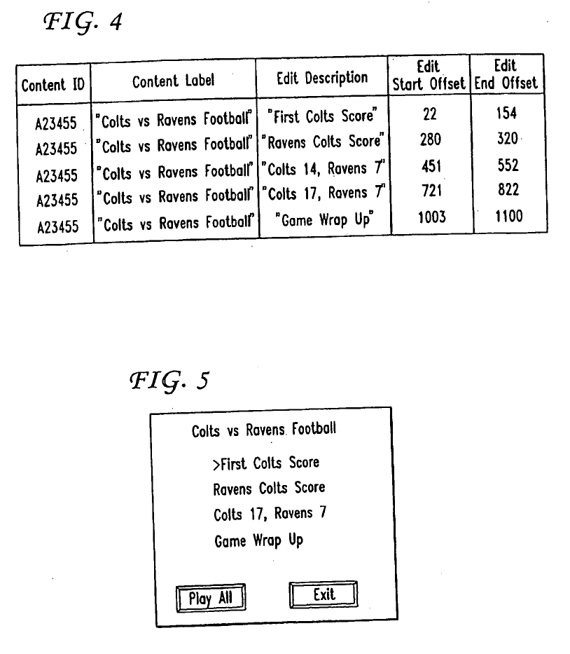

More specifically, FIG. 4 depicts an example simple declarative ELS in accordance with one embodiment of the present invention. The ELS of FIG. 4 illustratively comprises information that facilitates indexing and presentation regarding each segment. For example, the ELS of FIG. 4, comprises a plurality of segments of a previously recorded football game. As depicted in FIG. 4, the media content is given a Content ID number A23455 and a Content Label “Colts vs. Ravens Football” to identify and index the media content. The segments of the media content are further identified by a respective “Edit Description”. That is, the “Edit Description” label provides viable text and/or graphics to provide a summary guide readily identifiable by a user, for example “First Colts Score”, “Ravens First Score”. “Colts 14, Ravens”, “Colts 17, Ravens 7” and “Game Wrap Up”. The segments of FIG. 4 are further identified by an Edit Start Offset and an Edit End Offset. The Stan and End Offsets delimit the temporal cut points from the original media content.

In one embodiment of the present invention, an ELS is created using a media content receiver and an included ELS control unit. For example, in the media content system 100 of FIG. 1, the DVR Set Top Box 140 receives and records media content (e.g., audio/video content) from the remote media content source 120. The audio/video content from the media content source 120 is recorded on, for example, a hard drive disc or DVD, in the DVR Set Top Box 140. In various embodiments of the present invention, the DVR Set Top Box 140 includes a user input interface (not shown). The user input interface of the DVR Set Top Box 140 can comprise wireless remote controls, pointing devices, such as a mouse or a trackball, voice recognition systems, touch screens, on screen menus, buttons, and the like for providing control capabilities to a user. In such an embodiment of the present invention, a user uses the DVR Set Top Box 140 to play the recorded media content and, using the user input interface of the DVR Set Top Box 140, identifies the locations of desirable media segments in the media content. That is, using the user input interface of the DVR Set Top Box 140 a user is able to define an Edit List Script (ELS) in accordance with the present invention.

For example, in one embodiment of the present invention, the user uses the user input interface of the DVR Set Top Box 140 to mark and store, in the ELS control unit 110, time marks of the media content to identify the location and duration of segments of the media content to be listed in an ELS. The entire previously recorded media content can be played by the user for identifying any desirable and separable segments of the media content as described above.

In one embodiment of the present invention, a user enters and defines the time marks described above by, for example, entering the start time and the end time (e.g., Edit Start Offset and Edit End Offset) of the various media segments to be defined and recorded in an ELS in the memory of the ELS control unit 110. Alternatively, a user input interface of the DVR Set Top Box 140 is implemented to identify various media segments to be defined and saved as an ELS in accordance with the present invention by depressing a button of the user input interface of the DVR Set Top Box 140 to indicate the start of a media segment and by depressing the same, or alternatively a second button, to indicate the end of the media segment being defined. In the latter embodiment, the start and the end locations of each of the defined media segments would then be automatically recorded in the memory of the ELS control unit 110 and are associated with the particular ELS list being created. During the above described training of the present invention (i.e., the defining of the media segments), a user can start, stop, pause, rewind, and/or fast forward the previously recorded media content to define the desired media content segments in an ELS of the present invention.

In addition to defining and recording the locations of the media content segments in an ELS for the previously recorded media content, the original media content and the associated defined media segments are also identified. More specifically, an identifier for previously recorded media content, such as a title, is stored in the ELS control unit 110 such that the ELS control unit 110 is able to identify the specific media content if the ELS control unit 110 again receives the media content (i.e., the same media content is again played by the DVR Set Top Box 140). Information recorded in the ELS control unit 110 for identifying specific previously recorded media content may take the form as depicted in FIG. 4, above. In the embodiment of the present invention described above where the media content segments and the ELS is defined by a user using the user input interface of the DVR Set Top Box 140, identification information for the defined segments of the ELS can be added after each segment is defined (i.e., the playing of the recorded media content is paused and a user is given an opportunity to input identification information as described above), or alternatively a user may input identification information for the previously recorded media content and the defined media segments in the ELS after all of the media segments are identified as describe above (i.e., after the previously recorded media content has ended playing).

In accordance with the present invention, a user interface is provided for facilitating a user's selection of the desired media segments from the compiled ELS for creating an Edit Manipulation List. For example, FIG. 5 depicts an embodiment of a user interlace for user manipulation of the Edit List Script (ELS) of FIG. 4 and as such for creating an Edit Manipulation List such as an Edit Playback List. In one embodiment of the present invention, the user interface for creating an Edit Manipulation List of the present invention is created based on the label information identifying the media content segments in the ELS. For example, the user interface of FIG. 5 illustratively comprises a User Graphical Interface Menu that is created from the label information in the ELS of FIG. 4. The User Graphical Interface Menu can be displayed on, for example, the output device 150 of the media content broadcast system 100 of FIG. 1. A user selects which media content segments in the ELS are to be manipulated by, for example, selecting (i.e., clicking on, highlighting) the respective labels of the media content segments to be manipulated. Alternatively, a user may decide to use a “play all” feature to play all of the available media content segments. However, in alternative embodiments of the present invention, a user interface, such as the User Graphical Interface Menu of FIG. 5 is displayed on a display provided via the DVR Set Top Box 140 or the ELS control unit 110. Again, the User Graphical Interface Menu is provided to facilitate the creation of an Edit Manipulation List, such as an Edit Playback List, in accordance with the present invention. Although in the User Graphical Interface Menu of FIG. 5, the user interface is based on the label information in the ELS, in alternate embodiments of the present invention, the user interface of the present invention is based on substantially any information in the ELS for identifying the various separable media content segments.

Via a user interface of the present invention, such as the User Graphical Interface Menu of FIG. 5, a user is provided with a means for selecting which of the media segments of the ELS, created as described above, a user wishes to manipulate (e.g., play back, display, re-record, edit, etc.). As such, a user creates an Edit Manipulation List, such as an Edit Playback List, identifying which media segments the user wishes to manipulate. As previously described, the selected segments can be “spliced” together to create different playback scenarios or the selected segments can be indexed to facilitate direct access of individual playback of the selected segments. The selected media segments can also be manipulated to be recorded in a particular series. The Edit Manipulation List, such as an Edit Playback List, identifying which media segments the user wishes to manipulate is stored in the memory of the control unit of the present invention, such as the control unit 110 of the media content broadcast system 100 of FIG. 1.

In alternate embodiments of the present invention, instead of a user determining an ELS as described above, a media content receiver of the present invention, such as the DVR Set Top Box 140 of the media content broadcast system 100 of FIG. 1, receives a variety of Edit Lists Scripts (ELS) containing media segment information for user selection from a media content source along with the original media content. For example, a Broadcaster may be creating edit lists for highlights as a part of their broadcast process. Such edit list information may be used by, for example, the ELS control unit 110 of the present invention, to create the ELS of the present invention and as such, to identify the available media content segments for user manipulation and selection. Similarly a Content Owner may provide this information along with the original media content. Even further, such ELS information and, as such, media segment information, may be provided by a subscription service that identifies media segments in the original media content provided to the media content receiver of the present invention, such as the DVR Set Top Box 140 of the media content broadcast system 100 of FIG. 1, which comprises an ELS control unit of the present invention. Such information, as described above, is stored in the memory of an ELS control unit and can be used by the ELS control unit of the present invention to determine an ELS, as described above, for facilitating user selection of desired, available media segments for manipulation (e.g., display, playback, re-recording, etc.) and as such creating an Edit Manipulation List in accordance with the present invention. In addition, the ELS information (media segments) associated with a particular, original media content does not have to be delivered coincidently with the media content. In alternate embodiments of the present invention, ELS information is delivered at a different time than the original media content and through a completely different path than the broadcast path (e.g., a broadband connection).

Even further, various embodiments of the present invention further include the remote application of an Edit Manipulation List, such as an Edit Playback List, to stored media content within a media content receiver, such as the DVR Set Top Box 140 of the media content broadcast system 100 of FIG. 1. That is, in various embodiments of the present invention, Edit Manipulation List commands do not have to be resident on a local ELS control unit are communicated from a remote location. For example, a media content receiver of the present invention, such as the DVR Set Top Box 140 of the media content broadcast system 100 of FIG. 1, receives an Edit Manipulation List, such as an Edit Playback List, from a media content source along with the original media content. For example, a Broadcaster may include at least one Edit Manipulation List, such as an Edit Playback List, list as a part of their broadcast process. Such Edit Manipulation Lists may be used by, for example, the ELS control unit 110 of the present invention, to facilitate the selection of media segments identified by the Edit Manipulation Lists by a user by any of the means and methods described herein. Conversely, an Edit Manipulation List, such as an Edit Playback List, determined on a local ELS control unit can be communicated to a remote server, such as a broadcast server, to cause the broadcast server to, for example, only communicate the media segments identified by the Edit Manipulation List to a remote location, such as the local ELS control unit 110 of the DVR Set Top Box 140 of the media content broadcast system 100 of FIG. 1.

Alternatively, media content providers such as a subscription service. Content Owner, Broadcaster, etc., can provide Edit Manipulation Lists, such as Edit Playback Lists, and/or ELS information regarding available media segments in a particular media content to a subscriber on a medium which the subscriber can use to input the information into an ELS control unit of the present invention, such as the ELS control unit 110 of FIG. 1. For example, in such embodiments of the present invention, Edit Manipulation Lists and/or ELS information is provided to a subscriber in a downloadable format on the internet such that the Edit Manipulation Lists and/or ELS information can be downloaded over the Internet and copied onto a medium, for example a DVD, for transfer to the ELS control unit 110. In such embodiments of the present invention, a memory of the ELS control unit of the present invention is further adapted to receive information from a player of the medium, for example a DVD player, such that the Edit Manipulation Lists and/or ELS information regarding available media segments in a particular media content downloaded from the internet and copied onto the medium can be transferred to and stored in the memory of the ELS control unit using an external player of the medium. Alternatively, a media content receiver and/or an ELS control unit of the present invention can further include a media player such that Edit Manipulation Lists and/or ELS information provided by a subscription service or other means can be transferred to and stored in the memory of the ELS control unit using the media player. In any event, the particular media content must also be identified in the ELS control unit using any of the means described above.

That is, the original media content is again identified and the identification stored in a memory of the ELS control unit such thai if the previously received media content is ever received again by a media content receiver containing an ELS control unit of the present invention, such as the DVR Set Top Box 140 of the media content broadcast system 100 of FIG. 1, a stored ELS list associated with the received media content can be recalled to identify the previously determined media segments in the previously received media content. For example, if a sporting event was recorded by a digital recorder and an ELS identifying available media segments was previously determined for the sporting event, if that sporting event is again played, the previously determined ELS list can be recalled to again identify the available media segments in the recorded media content. Similarly, previously stored user selections (Edit Manipulation List) identifying which of the available media segments to manipulate (e.g., playback) can also be stored and identified as, for example, user playback lists.

Alternatively, if new ELS information is delivered with a previously identified original media content having a stored, associated ELS, the newly received ELS information can be used in place of or in conjunction with the previously stored ELS, or can be ignored altogether.

In various embodiments of the present invention, a media content receiver, such as the DVR Set Top Box 140 of the media content broadcast system 100 of FIG. 1, is adapted to receive and record multiple media contents from a single source or multiple sources. In such embodiments, an ELS control unit of the present invention, such as the ELS control unit 100 of the media content broadcast system 100 of FIG. 1, is adapted to store ELS information, and as such, associated available media segments, for various original media content and content sources. More specifically, in a media content broadcast system of the present invention, such as the media content broadcast system 100 of FIG. 1, an ELS control unit is adapted to create and store, as described above, respective ELSs for each of the received media contents. As such, the ELS control unit enables a user, via an available user interface as described above, to select any of the available media segments to be manipulated (e.g., displayed, played back). The selected media segments can be “spliced” together in substantially any order to create different playback sequences or they can be indexed to facilitate random access of individual playback segments. Even further, the various available media segments may be mixed to create a unique media playback sequence. Thai is, in various embodiments of the present invention a user is able to select, via a user interface, a source of media segments by selecting media segments from respective ELSs. Such a capability facilitates the mixing or replacement of original media content, such as mixing the audio of a radio broadcast with the video of a spoiling event in an Edit Playback List to be played back.

In accordance with the present invention, control information can also be included in the original media content which provides restrictions on the modification of the original media content during playback. More specifically, a media content source, such as a Content Owner, a Broadcaster, a Subscription Service and even a user, may provide a temporal map of what can and cannot be modified in the original content in a finally determined Edit Manipulation List. That is, the original media content can include indexed entry points that must appear in a final user selection of media segments (Edit Manipulation List), such as commercials, credits, copyright warnings, and the like. In addition, the control information can include advertising/highlighting entry labels. More specifically, the original media content can include information for highlighting specific labels in the Edit List Script and subsequently the Graphical User Interface and Edit Manipulation list, for example through color, graphics, video thumbnails, video, etc., in an attempt to get a user and subsequent viewers to watch specific portions of the media segments, for example commercials. In such embodiments of the present invention, not all label entries are equal.

Even further, information can be stored, for example in the memory of a control unit of the present invention, regarding which of the media content segments have been selected for manipulation over a determined period of time for providing tracking/reporting data (i.e., was a specific commercial segment watched). Such information can be used as part of an overall business strategy to ensure a viewer is watching particular media content segments.

While the forgoing is directed to various embodiments of the present invention, other and further embodiments of the invention can be devised without departing from the basic scope thereof. As such, the appropriate scope of the invention is to be determined according to the claims, which follow.

1. A method for dealing an Edit Manipulation List for previously recorded media content, comprising:
delimiting events in said previously recorded media content by identifying media segments within said previously recorded media content for manipulation; and
enabling a selective manipulation of said identified media segments.

2. The method of claim 1, wherein media segments in said previously recorded media content are identified by playing back said previously recorded media content and marking the locations of said media segments in said previously recorded media content.

3. The method of claim 1, wherein media segments in said previously recorded media content are identified from a list identifying at least the locations of said media segments in said previously recorded media content.

4. The method of claim 1, wherein media segments in said previously recorded media content are identified from information regarding said previously recorded media content received from a source of said previously recorded media content.

5. The method of claim 4, wherein the information regarding media segments in said previously recorded media content is retrieved from an electronic media source.

6. The method of claim 1, comprising storing an identifier for said previously recorded media content such that information stored for identifying said media segments in said previously recorded media content is again associated with said previously recorded media content upon receiving said previously recorded media content in the future.

7. The method of claim 1, wherein said enabling step comprises:
providing a means for selecting which of said identified media segments are to be manipulated.

8. The method of claim 1, wherein said Edit Manipulation List comprises an Edit Playback List and said manipulation comprises playing back selected ones of said identified media segments.

9. The method of claim 1, wherein each of said identified media segments are identified via a respective unique label.

10. The method of claim 9, wherein specific ones of said respective unique labels are edited to entice user selection of said specific ones of said identified media segments.

11. The method of claim 1, wherein the step of identifying media segments defines an Edit List Script.

12. The method of claim 1, wherein media segments selected for manipulation comprise said Edit Manipulation List.

13. The method of claim 12, wherein said Edit Manipulation List is determined remotely and applied locally.

14. The method of claim 12, wherein said Edit Manipulation List is determined locally and applied remotely.

15. The method of claim 1, further comprising;
providing control information for defining which of said identified media segments are available for selective manipulation.

16. The method of claim 15, wherein said control information defines specific ones of said identified segments that must be included in said Edit Manipulation List.

17. The method of claim 1, wherein said previously recorded media content comprises multiple media contents from a single source or multiple sources.

18. The method of claim 17, wherein identified media segments from any of said multiple media contents are able to be combined for selective manipulation.

19. An apparatus for creating an Edit Manipulation List for previously recorded media content comprising a memory for storing information and program instructions and a processor for executing said instructions, said apparatus adapted to perform the steps of:
identifying media segments within said previously recorded media content for manipulation; and
enabling a selective manipulation of said identified media segments.

20. The apparatus of claim 19, comprising a user interface for enabling a user to identify said media segments.

21. The apparatus of claim 20, wherein respective, unique labels for each of said identified media segments are determined using said apparatus and are stored in said apparatus.

22. The apparatus of claim 19, wherein said media segments are identified using information received and stored by said apparatus.

23. The apparatus of claim 22, wherein said information received comprises respective, unique labels for each of said identified media segments.

24. The apparatus of claim 22, wherein said information received comprises control information for defining which of said identified media segments are available for selective manipulation.

25. The apparatus of claim 19, comprising a user interface for enabling a user to determine which of said identified media segments are to be selectively manipulated.

26. The apparatus of claim 19, comprising a user interface and a display for determining which of said identified media segments are to be selectively manipulated.

27. A system for dealing an Edit Manipulation List for previously recorded media content, comprising:
a media content source for providing media content;
a media content receiver for receiving and recording said media content; and
a control unit in communication with said media content receiver including at least a memory for storing information and program instructions and a processor for executing said instructions, said control unit adapted to perform the steps of:
identifying media segments within said previously recorded media content for manipulation; and
enabling a selective manipulation of said identified media segments.

28. The system of claim 27, wherein said control unit is integrated into said media content receiver.

29. The system of claim 27, wherein said media content receiver comprises a digital recorder.

30. The system of claim 29, wherein said digital recorder comprises a digital video recorder.

31. The system of claim 27, wherein the step of identifying media segments defines an Edit List Script.

32. The system of claim 27, wherein media segments selected for manipulation comprise said Edit Manipulation List.

33. The system of claim 32, wherein said Edit Manipulation List is determined by said media content source and communicated to said control unit for defining which of said media segments are selected for manipulation.

34. The system of claim 32, wherein said Edit Manipulation List is determined by said control unit and communicated to said media content source for defining which of said media segments are to be communicated to said media content receiver.

35. The system of claim 27, wherein said media content source communicates control information to said control unit for defining which of said identified media segments are available for selective manipulation.

36. The system of claim 27, wherein each of said identified media segments are identified via a respective unique label.

37. The system of claim 36, wherein said media content source communicates information to said control unit for defining which of said respective unique labels are to be edited to stand-out to entice user selection of specific ones of said identified media segments.

38. The system of claim 27, wherein said control unit comprises a user interface and a display for determining which of said identified media segments are to be selectively manipulated.

39. The system of claim 27, further comprising a display device for displaying the selected media segments.

40. The system of claim 27, wherein information is stored regarding which of said media segments have been selected for manipulation for providing tracking information.
